(19) United States
(12) Patent Application Publication
(10) Pub. No.: US 2020/0235455 A1
(43) Pub. Date: Jul. 23, 2020

(54) WAVEGUIDE TRANSITION

(71) Applicants: Sergio E. Cardona, JR., Tucson, AZ (US); Kevin W. Patrick, Tucson, AZ (US); Joel Blumke, Tucson, AZ (US); Silvio Cardero, Tucson, AZ (US)

(72) Inventors: Sergio E. Cardona, JR., Tucson, AZ (US); Kevin W. Patrick, Tucson, AZ (US); Joel Blumke, Tucson, AZ (US); Silvio Cardero, Tucson, AZ (US)

(21) Appl. No.: 16/750,691

(22) Filed: Jan. 23, 2020

Related U.S. Application Data
(60) Provisional application No. 62/795,815, filed on Jan. 23, 2019.

(51) Int. Cl. H01P 5/107

(52) U.S. Cl. CPC H01P 5/107

(57) ABSTRACT

The present invention features a waveguide transition. A waveguide transition is used to join two dissimilar segments of waveguide, in this case coplanar waveguide to rectangular waveguide, and vice-versa. Care taken during the design of the waveguide transition ensures that the reflection of electromagnetic waves, which may be traveling along the coplanar waveguide segment and toward the waveguide transition and subsequent rectangular waveguide segment, is minimized.

### CROSS-REFERENCES TO RELATED APPLICATIONS

This application is a non-provisional and claims benefit of U.S. Provisional Application No. 62/795,815, filed Jan. 23, 2019, the specification(s) of which is/are incorporated herein in their entirety by reference.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a waveguide transition, which adapts one physical format for conveying electrical power into another physical format for conveying electrical power. In the present invention, the two formats under consideration are known to practitioners of the art as coplanar waveguide and rectangular waveguide. The coplanar waveguide connects to the front window (103), while the rectangular waveguide connects to the rear window (104).

FIG. 1A shows the coplanar waveguide has two conductors, namely, the center conductor, which mates identically with the front edge (121), and the grounded conductor, which mates identically with the front window (103). Meanwhile, the rectangular waveguide has one conductor, which mates identically with the rear window (104).

FIG. 1A shows that the number of conductors mismatches between two, for the coplanar waveguide, and one, for the rectangular waveguide. The waveguide transition, by the action of its container (100) in concert with its planar horn (120), accomplishes the requisite adaptation in a manner that is perceived to be smooth and invisible to electrical power traveling from the coplanar waveguide, through the waveguide transition (along a path (140) beginning from the front window (103), going around the planar horn (120), and exiting out the rear window (104)), and out of the rectangular waveguide. By a mathematical property of the waveguide transition called reciprocity, the reverse is also true: electrical power traveling from the rectangular waveguide, through the waveguide transition, and out the coplanar waveguide, sees equally as smooth and seamless a path.

FIG. 1B shows an important property of the present invention: the waveguide transition may be separated into upper and lower halves, by a geometric plane that may in some embodiments be only conceptual in nature, while in other embodiments the structure of the waveguide transition may be readily separable (and optionally joinable) into its two constituent halves along said geometric plane.

FIG. 1B shows the utility of the waveguide transition's separability is due to the fact that its upper chamber (130) and lower chamber (131) may be fabricated on separate printed circuit boards, and be joined as desired by a simple and inexpensive soldering operation. This existence of a mutual, well-defined, electrically optimal interface along the plane of the planar horn (120) made available by the present invention permits these separate printed circuit boards to be manufactured by separate firms, if desired, and still join seamlessly (from the view of electrical power flow) via the soldering operation. Existing alternatives to the present invention, for joining coplanar waveguide to rectangular waveguide on different plane levels, are complex, bulky, and expensive by contrast with the present invention. This invention thereby enables higher levels of system integration at negligible additional cost.

FIG. 2 shows another view of the waveguide transition, within a greater context, and demonstrates the case when the walls of the container (100) and the planar horn (120) have finite thickness. Beginning with the waveguide transition in the center, a section of coplanar waveguide has been extruded generally toward the figure's 3D eyepoint, such that it appears at the bottom of FIG. 2, while a section of rectangular waveguide has been extruded generally away from the figure's 3D eyepoint, such that it appears at the top of FIG. 2.

FIG. 3 shows an example embodiment of the present invention as the present invention may take its form from two sections of printed circuit board, indicated for instance by the upper chamber (130) and the lower chamber (131) at the far extents of FIG. 3. Extension lines demonstrate the joining of the upper chamber (130) and the lower chamber (131) into a single assembly, the container (100), that is held intact by a soldering operation along plane of the planar horn (120).

FIG. 3 shows that, in the example embodiment: the upper surface of the container (100) may be implemented by patterning the upper foil of the upper two-side plated dielectric lamina of printed circuit board stock; the sidewalls of the upper chamber (130) may be implemented by tight arrays of vias joining electrically the upper foil to the lower foil of the upper two-side plated dielectric lamina, wherein the arrays may be deemed tight by their inter-via pitch's being much less than one wavelength of the electromagnetic waves traveling in the coplanar waveguide or the rectangular waveguide; the instance of the planar horn (120) belonging to the upper chamber (130) may be implemented by patterning the lower foil of the upper two-side plated dielectric lamina; the instance of the planar horn (120) belonging to the lower chamber (131) may be implemented by patterning the upper foil of the lower two-side plated dielectric lamina; the sidewalls of the lower chamber (131) may be implemented by tight arrays of vias joining electrically the upper foil to the lower foil of the lower two-side plated dielectric lamina; the lower surface of the container (100) may be implemented by patterning the lower foil of the lower two-side plated dielectric lamina.

### DETAILED DESCRIPTION OF THE INVENTION

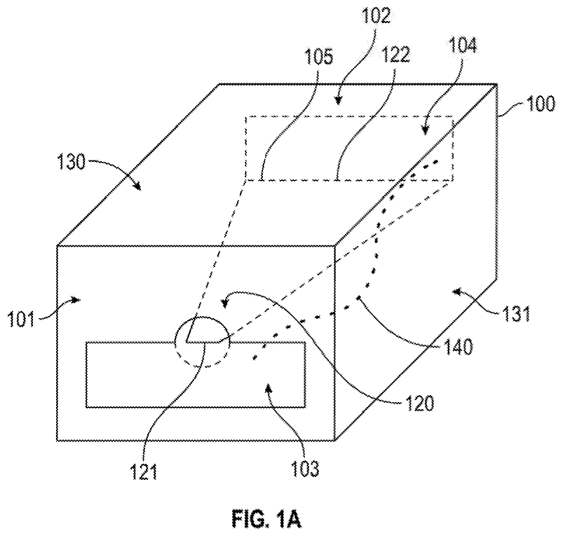

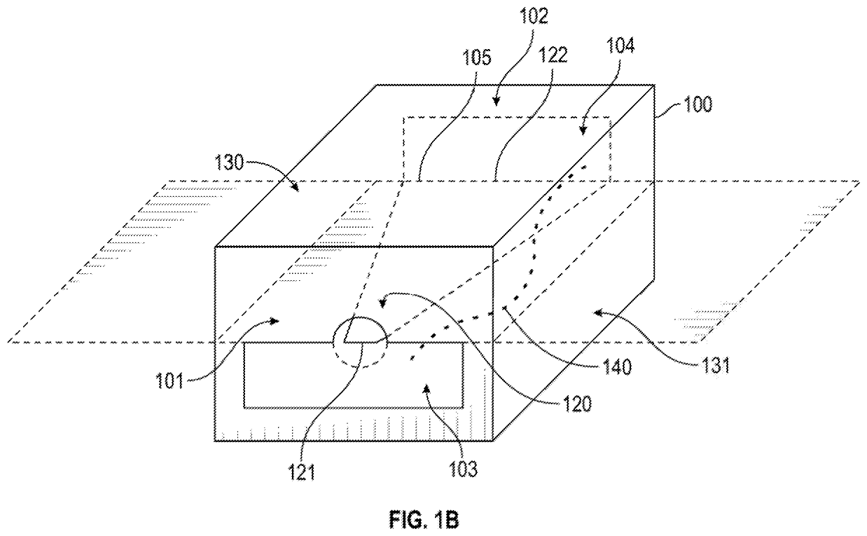

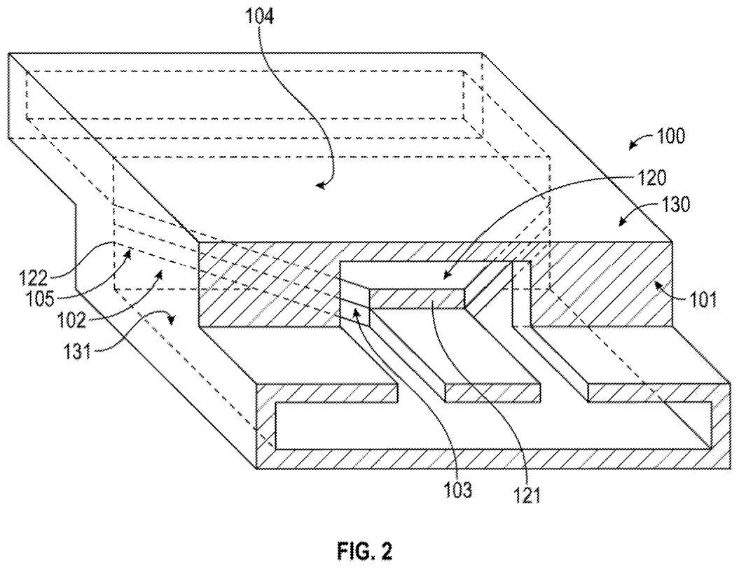

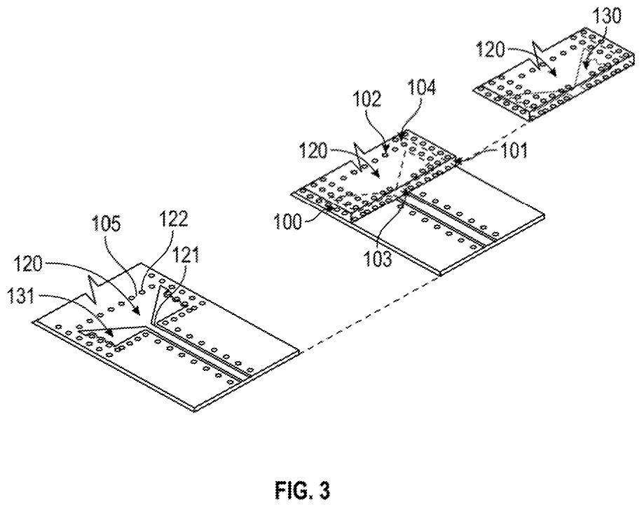

Referring to FIG. 1A, the present invention features a waveguide transition. A waveguide transition is used to join two dissimilar segments of waveguide, in this case coplanar waveguide to rectangular waveguide, and vice-versa. Care taken during the design of the waveguide transition ensures that the reflection of electromagnetic waves, which may be traveling along the coplanar waveguide segment and toward the waveguide transition and subsequent rectangular waveguide segment, is minimized.

In some embodiments, the waveguide transition may comprise a container (100) with a front face (101), a rear face (102), a front window (103), and a rear window (104). In the interest of efficiency and to avoid the escaping of noisome electromagnetic waves and field coupling, the waveguide transition contains the electromagnetic wave power that enters the waveguide transition through the front window (103), and permits said electromagnetic wave power to exit only via the rear window (104). Because the waveguide transition joins waveguides on two separate levels, the waveguide transition's front face (101) seals off the front end of the rectangular waveguide segment that mates with the waveguide transition's rear window (104); likewise, the waveguide transition's rear face (102) seals off the rear end of the coplanar waveguide segment that mates with the waveguide transition's front window (103).

The container (100) may be electrically conductive. The containment of electromagnetic wave power and fields is best accomplished by employing electrically conductive materials, typically elemental metals or alloys of copper, gold, silver, nickel, and tin.

The front window (103) may be planar and may perforate the front face (101). The flush mating of the coplanar waveguide segment with the waveguide transition is most easily accomplished when the front window lies in a geometric plane. Again, the flush mating is desirable to avoid the escaping of noisome electromagnetic waves and field coupling. This plane also defines the extent of the planar horn (120) (whose function is inextricable from that of the container (100) in accomplishing the performance of the waveguide transition) within the waveguide transition.

The rear window (104) may perforate the rear face (102) and may have an interface edge (105). Clearly, the electromagnetic wave energy that enters the waveguide transition needs an avenue by which to exit the waveguide transition. That avenue may be the rear window (104), which lies in the rear face (102), and may join by electrical conduction with the planar horn (120) along the rear window's (104) interface edge.

In some embodiments, the waveguide transition may further comprise a planar horn (120) with a front edge (121) and a rear edge (122). The planar horn (120) may play an essential role in interfacing the two dissimilar segments of waveguide, coplanar waveguide and rectangular waveguide. Because the planar horn (120) may interact strongly with both dissimilar waveguide segments, the planar horn (120) has a front edge (121) lying in the front window (103), and a rear edge (122) lying in the rear window (104).

The planar horn (120) may be electrically conducting. The containment of electromagnetic wave power and fields may be best accomplished by employing electrically conductive materials, typically elemental metals or alloys of copper, gold, silver, nickel, and tin.

The rear edge (122) may electrically connect to the interface edge (105) along its entire extent. The planar horn's (120) rear edge (122) may join by electrical conduction with the rear window's (104) interface edge (105).

The planar horn (120) may extend and taper toward the front face (101) from the rear edge (122), bisecting the interior of the container (100) into an upper chamber (130) and a lower chamber (131). The geometric plane including the planar horn (120) may divide the container (100) roughly in half. The halves may be known as the upper chamber (130) and the lower chamber (131). Because the conductor on the coplanar waveguide segment that joins with the planar horn may be narrower than the rear window's (104) interface edge (105), the planar horn (120) may taper toward the front window (103) and the front face (101). The exact nature of this taper may be a straight line (linear taper), obey some non-linear mathematical description (exponential taper), or be something else.

The front edge (121) may lie in the plane of the front window (103) without touching any edge of the front window (103). Again, the front edge (121) of the planar horn (120) may not be permitted to touch the boundary of the front window (103), since the coplanar waveguide segment may have two distinct conductors. Additionally, the front edge (121) may reach the coplanar waveguide segment's center conductor, which itself may end in the plane of the front window (103).

In some embodiments, a path (140) is created to guide electromagnetic wave energy. The entire conception and rationale for creating the waveguide transition may be to create an appropriate path (140) that guides electromagnetic energy from the front window (103) to the rear window (104) while minimizing the reflection of electromagnetic waves due to the waveguide transition. The path (140) constitutes a fluid connection between the front window (103) and the rear window (104).

As seen in FIG. B, the path (140) can be traced from the front window (103) through the lower chamber (131) around the planar horn (120) through the upper chamber (130) and to the rear window (104). The path (140), along with its mirror image around the opposite side of the planar horn (120), may be the only routes (since electromagnetic wave power may rapidly extinguish itself were it permitted to travel within the metal conductors of the container (100) or the planar horn (120)) by which electromagnetic wave power may transit the waveguide transition.

The path (140) may minimize the reflection of incident electromagnetic wave energy and maximize the transmission of incident electromagnetic wave energy. Indeed, the path (140) that remains open once the geometry of the container (100) and the planar horn (120) may have been specified, may be chosen for the express purpose of minimizing the reflection of incident electromagnetic wave energy and, since the waveguide transition may be nearly lossless, of necessity maximizing the transmission of electromagnetic wave energy. The path (140) may constitute a fluid connection between the front window (103) and the rear window (104).

### Example

The following is a non-limiting example of the present invention. It is to be understood that said example is not intended to limit the present invention in any way. Equivalents or substitutes are within the scope of the present invention.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A waveguide transition comprising:
a. a container (100) having a front face (101), a rear face (102), a front window (103), and a rear window (104), wherein the container (100) is electrically conducting, wherein the front window (103) perforates the front face (101), wherein the front window (103) is planar, wherein the rear window (104) perforates the rear face (102), wherein the rear window (104) has an interface edge (105);
b. a planar horn (120) having a front edge (121) and a rear edge (122), wherein the planar horn (120) is electrically conducting, wherein the planar horn (120) bisects the container (100) into an upper chamber (130) and a lower chamber (131), wherein the rear edge (122) connects electrically to the interface edge (105) along its entire extent, wherein the planar horn (120) extends toward the front face (101), wherein the planar horn (120) tapers from the rear edge (122) toward the front edge (121), wherein the front edge (121) lies in the plane of the front window (103), wherein the front edge (121) lies within and without touching the front window (103);
wherein a path (140) is created to guide electromagnetic wave energy, wherein the path (140) can be traced from the front window (103) through the lower chamber (131) around the planar horn (120) through the upper chamber (130) to the rear window (104), wherein the path (140) minimizes the reflection of incident electromagnetic wave energy, wherein the path (140) maximizes the transmission of incident electromagnetic wave energy.
